(19) United States
(12) Patent Application Publication
(10) Pub. No.: US 2018/0177660 A1
(43) Pub. Date: Jun. 28, 2018

(54) ATTACHMENT DEVICE

(71) Applicant: Techdent Limited, London (GB)

(72) Inventors: Phillip Davies, London (GB); Laraine Wright, London (GB)

(21) Appl. No.: 15/738,311

(22) PCT Filed: Jun. 23, 2016
(86) PCT No.: PCT/GB2016/051870

§ 371 Date: Dec. 20, 2017

(30) Foreign Application Priority Data
Jun. 23, 2015 (GB) 1511061.2

(51) Int. Cl. A61G 15/16; F16B 2/08; F16B 2/00; F16B 21/04; F16M 13/02

(52) U.S. Cl. CPC A61G 15/16; F16B 2/08; F16M 13/022; F16B 21/04; F16B 2/005

(57) ABSTRACT

An attachment device (10) for attaching accessories to a support comprising a connector (14) for connecting to a device to be supported, and a strap (11), the strap (11) having a support region (12) mounting the connector (14), and first and second flexible engagement portions (16, 18); the first engagement portion 16 including a plurality of spaced deformable fins (20) extending from one side thereof and a plurality of through apertures (24) spaced along the length of the first engagement portion (16), the second engagement portion (18) including a plurality of spaced deformable fins (22) extending from one side thereof, and at least one upstand (26, 28) extending from the other side thereof adapted to enter and engage with at least one of the through apertures (24) of the first engagement portion (16).

The present invention relates to an attachment device for attaching an accessory to a support, for example, a tissue holder to a dental chair.

### BACKGROUND TO THE INVENTION

When a patient is receiving dental care at a visit to the dentist, the patient is generally positioned in an adjustable chair, which enables the dentist to move the patient between a sitting position and a substantially recumbent position for examination of the patients' teeth. Adjacent the chair, a spitoon is provided with a tap, primarily for enabling the patient to rinse their mouth and a disposable cup containing a mouthwash is often provided for the patient to rinse between dental procedures, as directed by the dentist.

Often, a patient will need to wipe the area around their mouth after treatment. To do this, a dental nurse generally passes the patient a tissue. This is not ideal, because the dental nurse has to be at hand, rather than attending to other matters, such as preparing instruments or materials. To mitigate this problem, a dentist or dental nurse may attach a box of tissues to a support member of the chair using an elastic band. This is highly undesirable, because this arrangement is unhygienic, can fail in use and looks unprofessional and incongruous in a medical treatment environment. Aside from the spitoon, a dental chair may have a number of support members, typically articulating tubular supports, for supporting lighting and dental instrument tables.

Dental chairs are also typically not provided with mirrors for patient use, and hence the dentist has to show the patient their dental work, using a hand held mirror. This can be highly inconvenient for the dentist.

Furthermore, not all dental chairs have any means of displaying visual material for either keeping a patient entertained and informed during a dental procedure or for viewing dental x-rays in a ‘heads up’ position.

It is an object of the present invention to substantially reduce or obviate the aforementioned problems.

### STATEMENT OF INVENTION

According to a first aspect of the present invention, there is provided an attachment device for attaching accessories to a support comprising
a connector for connecting to a device to be supported, and
a strap, the strap having a support region mounting the connector, and first and second flexible engagement portions;
the first engagement portion including a plurality of spaced deformable fins extending from one side thereof, and a plurality of through apertures spaced along the length of the first engagement portion,
the second engagement portion including a plurality of spaced deformable fins extending from one side thereof, and at least one upstand extending from the other side thereof adapted to enter and engage with at least one of the through apertures of the first engagement portion.

The attachment device is advantageous because it provides a way of supporting a number of accessories, for example, a tissue box holder, from a chair. In particular the attachment device enables support from one of the tubular support members, or other shapes of support member, and the projections on the engagement portions facilitate a good grip. The strap can form a closed loop of various different sizes, depending on which apertures are engaged with the upstands, allowing the strap to accommodate various sizes and shapes of support. The attachment device can be used in various scenarios, including dental, medical and/or veterinary settings.

The fins engage one another when wrapped around an object and significantly increase the degree to which the object is gripped, by resisting movement relative to neighbouring fins. The fins are deformable to conform to different supports.

The strap may be integrally formed from rubber to provide flexibility and resilience, when engaging the engagement portions with one another or stretching the strap around a support, for example. Alternatively, the strap may be integrally formed from silicone. Further alternatively, the strap may be formed from a thermoplastic elastomer (TPE) or a thermoplastic polyurethane (TPU).

The first and second engagement portions may extend away from the support region, to the same side of the support region, and may be spaced apart from each other. This provides a gap in which a support can be conveniently positioned for engagement by the strap.

The plurality of projections on the first and second engagement portions are in the form of spaced fins. The fins may extend laterally across the first and second engagement portions. The fins may alternatively be described as webs or ribs on the engagement portions. Preferably, the fins on the first engagement portion face the fins on the second engagement portion. More preferably, the fins substantially decrease in depth with distance from the support region. In other words, the fins may taper away from the support region.

Using laterally spaced fins increases the barrier for rotation of the attachment device around the support when the strap is engaged. This is because the fins collectively require significant force to undergo deformation, providing much more grip than would be achieved from surface friction with the engagement portions without the fins. The opposing spaced fins can deform around the support when the strap is engaged, giving a degree of flex which permits secure attachment at one of the sizes of closed loop of the strap. It also maximises the engaged surface area for an irregularly shaped support. By decreasing in depth away from the support region, the fins can even more easily conform to the shape of an arm rest or rail, for example, and poles of different diameters and shapes.

First and second spaced upstands may be provided on the other side of the second engagement portion to the projections. Preferably, the spacing of the first and second upstands corresponds to the spacing of the plurality of through apertures in the first engagement portion.

The upstands allow the first engagement portion to connect to the second engagement portion, securing the strap. Having the spacing of the upstands match that of the apertures maximises the range of possible configurations for the strap, irrespective of which apertures are used to engage the upstands.

The first upstand closest to the support portion may have a first height and may have a lip provided at its distal end. The second upstand may have a second height, taller than the first height, and may have a first lip located part way along its length and a second lip at its distal end. The first engagement portion may be attachable to the second engagement portion to form a closed loop for gripping an elongate member. This may be achieved by engaging adjacent apertures on the first and second upstands.

When apertures are engaged with the upstands, the lips of each upstand bear against the apertures to retain the first engagement portion in connection with the second engagement portion on both upstands. The lips prevent accidental disengagement of the strap in use, if accidentally caught.

The first engagement portion may also be folded back on itself and engaged with a further aperture on the second upstand. For example, when the attachment device is attached to a support of lesser diameter, a section of the strap at the distal end of the first engagement portion will hang freely from the upstands. To prevent this becoming caught on clothing or apparatus, for example, this section can be folded back and engaged with the upper section of the second upstand, which retains it in an unobtrusive position.

The connector may have a substantially central plate with connection means extending to one side for engaging a corresponding connector and a spigot extending to the other side adapted to engage in an aperture or recess in the support region of the strap. The connector may be overmoulded by the strap.

This allows the connector to be engaged with and retained by the attachment device, at the spigot, whilst providing a region to securely attach another device, at the connection means.

The shape of the spigot may be substantially non-circular, to prevent rotation of the connector relative to the strap, when engaged in the support region, preventing movement or accidental disconnection in use. For example, the spigot may include radial ridges. The radial ridges may be provided on a circular section, but the overall shape may be substantially non-circular, so that the connector can bear against portions of the strap. Alternatively, the spigot may be substantially circular. This may be appropriate where the strap is overmoulded around the connector, for example. Holes or recesses may be provided in the spigot into which portions of the overmoulded strap may extend, preventing rotation of the connector relative to the strap.

The connection means may be a male or female bayonet connector. Preferably, the connection means is a male bayonet connector including a central member, having at least one radial protrusion. More preferably, a plurality of spaced protrusions extend radially from the central member. Yet more preferably, four equally angularly spaced protrusions extend radially from the central member.

A female bayonet connector may be provided including a receiving area for receiving the central member and the at least one radial protrusion of the male bayonet connector. When the receiving area has received the central member and at least one radial protrusion, relative rotation of the male and female connectors may cause the at least one protrusion to move under a surface of the female connector, preventing axial separation of the connectors. A snap fit joint may be provided between the at least one radial protrusion and a wall of the female bayonet connector.

The bayonet connectors allows for quick attachment/release of another device to/from the attachment device by axial alignment and rotational locking of the attachment device to the other device. The four radial protrusions secure the connection to the female connector in four different places against axial disconnection, providing a balanced connection. The snap fit joints provide a means of locking the connectors together by hand, when rotated relative to each other, with haptic feedback as the connectors lock into place to signal that the connection is secure. By using four snap fit joints, the rotational force required to release the connection is increased to a suitable level to avoid accidental release of the connector.

A tissue box holder may be mounted to the female bayonet connector. Alternatively, a mirror may be mounted to the female bayonet connector. Further alternatively, a clamp may be mounted to the female bayonet connector. These devices allow a dentist or patient, for example, to readily access and use tissues or a mirror without needing someone else to hold them. If the dentist requires information during a procedure via a tablet computer, for example, the clamp secures the tablet in place for quick reference. A patient can also be entertained by media provided on a tablet, during a procedure.

The clamp may include adjustable first and second opposing jaws slidably connected to a body portion. The body portion may include a ratchet mechanism switchable between a locked configuration, where the first and second jaws cannot be spread apart, and an unlocked configuration, where the first and second jaws can be moved freely. Preferably, the ratchet mechanism includes a ratchet and a spring-loaded pawl arranged for engagement with the ratchet, where the pawl engages the ratchet in the locked configuration.

The slidable jaws enable adjustment of the clamp to fit different sizes of tablet, for example. The ratchet mechanism allows the jaws to be quickly brought together to securely clamp the tablet, requiring only a single movement of the jaws to fully clamp in place, and preventing subsequent opening of the jaws which might cause the tablet to fall. The unlocked configuration allows the tablet to be removed after a procedure, for example, or for replacement by another device.

According to a second aspect of the invention, there is provided a clamp for supporting a display, the clamp comprising first and second opposing arms connected to a body, a grip area being provided at the end of each arm, and an arm adjustment mechanism slidably connecting the arms to the body, the mechanism being operable to slide and lock the arms in one or more positions relative to the body, an adapter being provided on the body for connection to an attachment device according to the first aspect of the invention.

Preferably, either or both grip areas include a plurality of spaced fins. The or each plurality of spaced fins may be deformable. Preferably, the adapter includes a bayonet connector having a receiving area for receiving a corresponding bayonet connector, one of the bayonet connectors having one or more radial protrusions disposed to engage one or more corresponding latches in the other connector during relative rotation of the engaged connectors, preventing axial separation of the connectors.

The clamp may include one or more features of the bayonet connector described for the first aspect of the invention.

According to a third aspect of the invention, there is provided a mirror comprising a frame having an adapter for connection to an attachment device according to the first aspect of the invention, the adapter including a bayonet connector having a receiving area for receiving a corresponding bayonet connector, one of the bayonet connectors having one or more radial protrusions disposed to engage one or more corresponding latches in the other connector during relative rotation of the engaged connectors, preventing axial separation of the connectors.

The mirror may include one or more features of the bayonet connector described for the first aspect of the invention.

According to a fourth aspect of the invention, there is provided a tissue box holder comprising an open-ended body for receiving a tissue box, and an adapter on the body for connection to an attachment device according to the first aspect of the invention, the adapter including a bayonet connector having a receiving area for receiving a corresponding bayonet connector, one of the bayonet connectors having one or more radial protrusions disposed to engage one or more corresponding latches in the other connector during relative rotation of the engaged connectors, preventing axial separation of the connectors.

The tissue box holder may include one or more features of the bayonet connector described for the first aspect of the invention.

According to a fifth aspect of the invention, there is provided a kit comprising an attachment device according to the first aspect of the invention, and one or more of the following: a clamp according to the second aspect of the invention; a mirror according to the third aspect of the invention; a tissue box holder according to the fourth aspect of the invention.

### BRIEF DESCRIPTION OF THE DRAWING(S)

For a better understanding of the present invention, and to show more clearly how it may be carried into effect, reference will now be made by way of example only to the accompanying drawings, in which:

FIG. 1A shows a side view of an attachment device of the invention in an open configuration;

FIG. 1B shows a perspective view of the attachment device of FIG. 1;

FIG. 2 shows a side view of the attachment device of FIG. 1 in a closed configuration;

FIG. 3A shows a side perspective view of a connector of the attachment device of FIG. 1 in isolation;

FIG. 3B shows an upper perspective view of the connector of FIG. 3 in engagement with an adapter;

FIG. 4 shows a perspective view of the attachment device of FIG. 1 connected to the adapter of FIG. 3B, further connected to a tissue box holder;

FIG. 5 shows a perspective view of the attachment device of FIG. 1 connected to the adapter of FIG. 3B, aligned for connection with a first embodiment of a clamp;

FIG. 6A shows a cross-sectional side view of a locking mechanism of the clamp of FIG. 5;

FIG. 6B shows a further cross-sectional side view of the locking mechanism of FIG. 6A with selected components hidden for clarity;

FIG. 7A shows a front perspective view of a tissue box adapter for engagement to the connector of FIG. 3A and the tissue box holder of FIG. 4;

FIG. 7B shows a rear perspective view of the tissue box adapter of FIG. 7A;

FIG. 8A shows a front perspective view of a mirror adapter for engagement to the connector of FIG. 3A and a mirror;

FIG. 8B shows a rear perspective view of the mirror adapter of FIG. 9A;

FIG. 9A shows a front perspective view of a clamp adapter for engagement to the connector of FIG. 3A and another device, such as a tablet computer;

FIG. 9B shows a rear perspective view of the clamp adapter of FIG. 8A;

FIG. 10A shows a front perspective view of a second embodiment of a clamp;

FIG. 10B shows a front plan view of the clamp of FIG. 10A, with the front cover removed to illustrate an internal clamping mechanism; and

FIG. 10C shows a rear plan view of the clamp of FIG. 10A, with the rear cover removed to illustrate the internal clamping mechanism.

### DESCRIPTION OF PREFERRED EMBODIMENT(S)

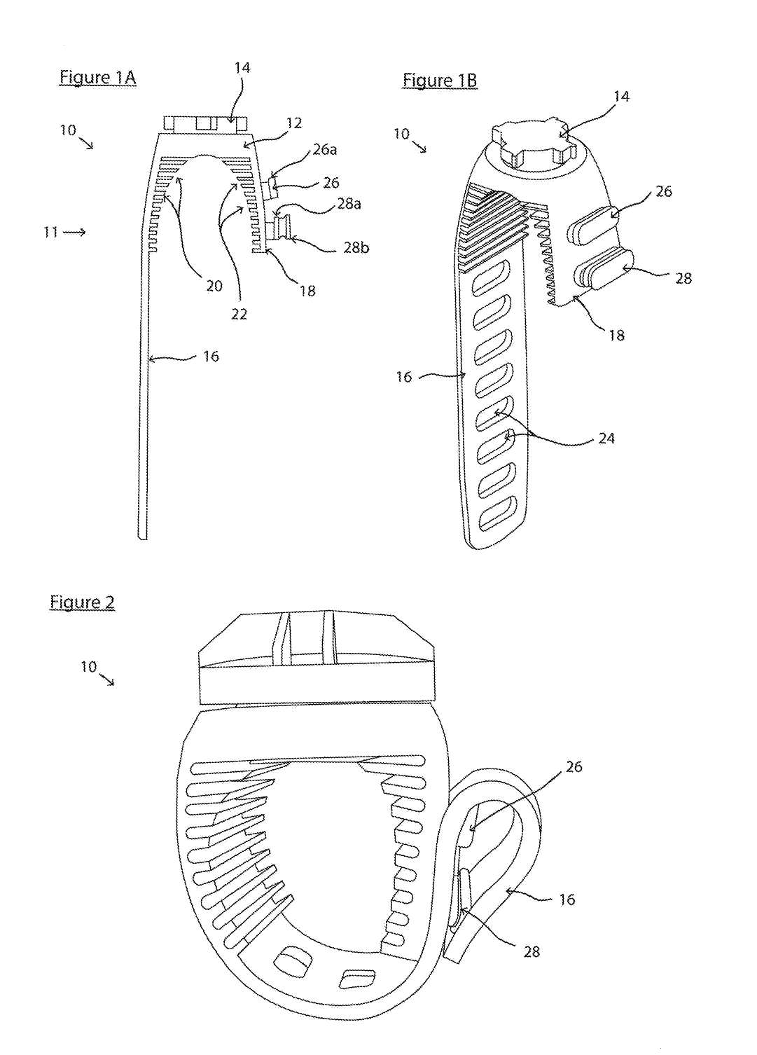

Referring firstly to FIGS. 1A to 4, there is provided an attachment device indicated generally at 10. The attachment device 10 includes a strap 11 having a support region 12, and a connector 14 that removably fits through and engages an aperture in the support region 12. In alternate embodiments, the connector 14 may instead be formed integrally with the support region 12. The connector 14 lies proud of one side of the support region 12. The support region 12 includes a concave portion on its underside to accommodate a support (not shown) to which the attachment device 10 can be connected. The attachment device 10 is shown in an open configuration in FIGS. 1A and 1B.

The support region includes a first engagement portion 16 and a second engagement portion 18, both of which extend away from the support region in the opposite direction to the connector 14. Each engagement portion 16, 18 is disposed on opposing sides of the support region 12. Each engagement portion 16, 18 is a flexible arm. The first engagement portion 16 is longer than the second engagement portion 18. The support region 12 and engagement portions 16, 18 are integrally formed, but could be formed from separate components, connected together. The support region 12 and engagement portions 16, 18 are made from silicone rubber.

The first and second engagement portions 16, 18 each include a number of spaced webs or fins 20, 22 extending laterally towards each other from opposing faces of the respective arms 16, 18. The fins 20, 22 may be equivalently described as webs. In this embodiment, the fins 20, 22 gradually increase in length with increasing proximity to the support region 12. The first engagement portion 16 also includes a number of lateral apertures 24 evenly spaced downwardly along the portion 16 beneath the fins 20 on the first engagement portion 16.

As seen in FIG. 2, there are nine fins on each of the engagement portions 16, 18. The four fins 20, 22 most distant from the support region 12 are smallest and all approximately the same size. The next three fins 20, 22 closer to the support region 12 on each engagement portion 16, 18 become gradually longer relative to the previous fins. Then, on the first engagement portion 16, the two uppermost fins 20 have chamfered ends. The same is true of the two uppermost fins 22 on the second engagement portion 18. The ends of the relevant fins 20, 22 are chamfered such that the uppermost fins are asymmetric about a substantially horizontal plane as viewed (i.e. with a longer upper face than lower face). Collectively, this means that the fins 20, 22 each define an internal curve that allows the fins to wrap around a support more effectively.

The second engagement portion 18 has a first upstand 26 and a second upstand 28, each oriented laterally across the opposite surface to the fins 22, i.e. on the exterior of the second engagement portion 18. The first upstand 26 has a lip 26a at its distal end, furthest from the exterior of the second engagement portion 18. The second upstand 28 has a primary lip 28a partway along its length, and a secondary lip 28b at its distal end, furthest from the exterior of the second engagement portion 18. In other words, the first upstand 26 has one tier, and the second upstand 28 is two-tiered. The second upstand 28 is taller than the first upstand 26, as measured from the surface of the second engagement portion 18. The heights of the lip 26a and the primary lip 28a are substantially the same.

Referring in particular to FIG. 2, the first engagement portion 16 can be wrapped around a support (not shown) and attached to the second engagement portion 18, i.e. in the manner of a typical strap and fastening. The first arm 16 is securable to the second arm 18 by passing each upstand 26, 28 through a given aperture 24, forming a closed loop (or closed configuration). Excluding the lips 26a, 28a, 28b, each of the upstands 26, 28 has a cross-sectional area smaller than that of each aperture 24. Including the lips 26a, 28a, 28b, each of the upstands 26, 28 has a cross-sectional area slightly larger than that of each aperture 24.

Each aperture 24 is stretchable to enable the apertures 24 to be engaged with one of the upstands 26, 28. If the upstands are used to engage apertures 24 further up the first engagement portion 16, i.e. apertures 24 lying closer to the support region 12, then a distal section of the first engagement portion 16 becomes a loose flap. To prevent this becoming caught on anything, e.g. a dentist's sleeve during movement, one of the apertures 24 in the distal section can looped backwards onto the second tier of the second upstand 28, as seen in FIG. 2.

Note that the uppermost portion of FIG. 2 is not visually representative of the adapters for the connector 14 in the following sections of description.

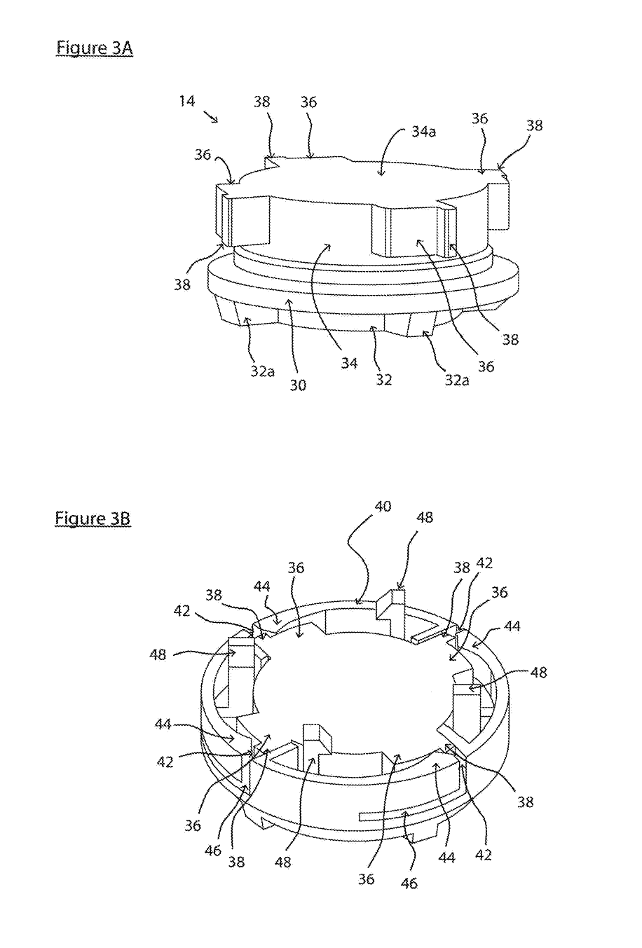

Referring now to FIG. 3, the connector 14 includes a central plate 30 with a spigot 32 for engaging the aperture of the support region 12. The spigot 32 is irregularly-shaped to prevent rotation of the spigot 32 within the aperture of the support region 12 when inserted. The spigot 32 includes radial ridges 32a (two of which are visible in FIG. 3A, two of which are hidden) which slot into corresponding recesses within the aperture of the support region 12. The connector 14 can be secured to the support region 12 by engaging the central plate 30 and the spigot 32 within the support region 12. It will be appreciated that other shapes and anti-rotation means are envisaged within the scope of the claims.

As seen in FIG. 3A, the connector 14 includes a male bayonet connector 34 on the opposite side of the central plate to the spigot 32. The male bayonet connector 34 includes a central member 34a, substantially circular as shown, that lies proud of the support region 12 when the connector 14 is held within the support region. The male bayonet portion 34 also includes four protrusions 36 that extend radially outwards from the side of the central member. Each protrusion 36 is mutually perpendicular to its neighbouring protrusion 36, being equally spaced around the male bayonet portion 34. Each protrusion 36 further includes a projection or nub 38 at its distal end. Each nub 38 is offset to one side of the respective distal end. Each nub 38 is rounded. The tips of each nub 38 correspond to a maximum diameter of the male bayonet connector 34.

The male bayonet connector 34 connects with a female bayonet connector 40 as shown in FIG. 3B. The female bayonet connector 40 is in the form of a resilient ring that encircles the male bayonet connector 34 when located thereon. The female connector 40 can be rotated relative to the male bayonet connector 34 (or vice versa, or both rotated concurrently in opposite directions) to securely lock the connectors together, preventing axial separation. This is achieved via a snap-fit connection (or snap-fit joint), described below, which is based on the interaction of the radial protrusions 36 and the nubs 38 of the male connector 34 with corresponding features of the female bayonet connector 40. Only a 45° turn is needed to lock the connectors together.

The female connector 40 includes an inwardly-facing circumferential flange, which has four spaced apertures therein to form four separate ledges or surfaces that extend perpendicularly inward from the ring. The size of each ledge substantially corresponds to the distance between a given pair of nubs 38. Ramps 44 are provided adjacent to each ledge, rising inwardly and asymmetrically out of the ring. The slope of each ramp 44 gradually increases in height to a peak which corresponds to a minimum diameter of the ring, as measured relative to points on each ramp 44 respectively. There are recesses 42 provided after each peak, each of which corresponds to the size and position of each nub 38 of the male connector 34.

The female connector 40 connects to the male connector 34 by initially aligning the ledges and radial protrusions to be out of phase and then pushing the male connector 34 into the female connector 40 until they abut. The female connector 40 can then be rotated relative to the male connector 34 to latch them together.

During rotation, the nubs 38 approach the peaks of the ramps 44. However, the minimum diameter of the ring created by the peaks is slightly smaller than the maximum diameter of the male connector 34 created by the nubs 38. Consequently, the rotational force applied must be sufficient for the nubs 38 to overcome friction and slide past the peaks. Rotation of the female connector 40 in the opposite direction with sufficient force is also required for later disengagement of the connectors 34, 40. The female connector 40 includes four L-shaped slots 46 (two of which are visible in FIG. 3B). These slots 46 are spaced at 90° intervals around the connector 40. Each slot 46 is disposed partly behind its respective recess 42 and partly adjacent to its respective ramp 44. Each of the slots 46 creates a flexible arm portion that can flex outwardly under pressure when the male and female connectors 34, 40 are being engaged in the manner described above. In other words, the flexible arms act as latches.

Once the nubs 38 are past the peaks, the flexible arms return to their normal positions in the ring and the nubs 38 are retained within the recesses 42, preventing accidental rotational disengagement. At the same time, the ledges are disposed beneath the radial protrusions 36, meaning that (whilst engaged) the snap-fit connection prevents direct axial disengagement of the male and female portions 34, 40, as the ledges bear against the radial protrusions 36.

Four resilient clips 48 are provided extending from the female connector 40 for connection with undercut apertures in a device to be engaged. Each clip 48 is inset within the ring. Each clip 48 extends perpendicularly away from its respective ledge through the ring and terminates in a hook above the ring. The clips 48 also spaced at 90° intervals around the connector 40. Each clip 48 is oriented to face in a different direction relative to its neighbouring clips 48. The slots 46 and clips 48 are rotationally offset to be in anti-phase, i.e. the slots 46 and clips 48 are spaced around the female connector 40 every 45° in an alternating manner. It will be appreciated that any number of slots and any number of clips may be used in alternate embodiments.

The clips 48 allow another device to be engaged by the female connector 40. In other words, the female connector 40 is an adapter that allows various devices to be attached to the attachment device 10. It will be appreciated that the strap 11 may include the female connector 40 and the male connector 34 may function as an adapter for another device in alternate embodiments.

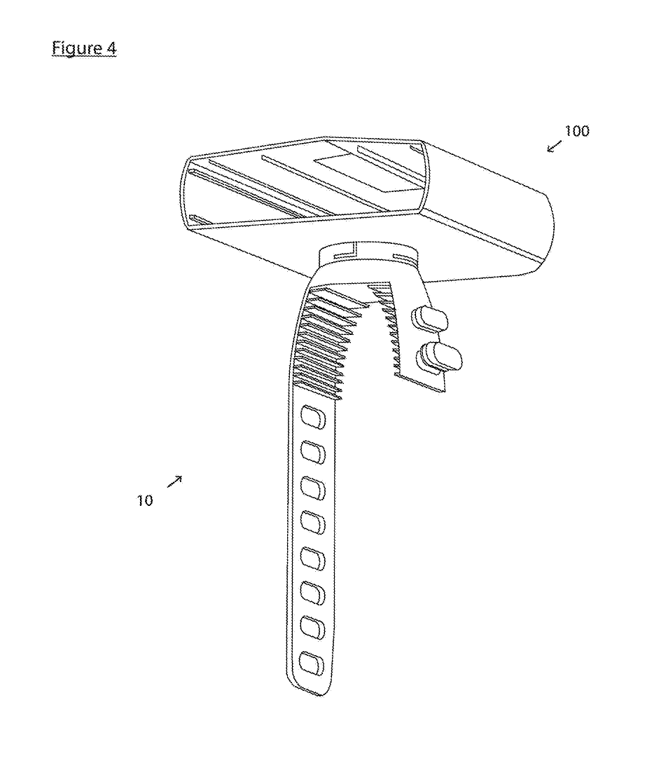

The clips 48 are arranged to face in different directions at 90° to one another, so a device connected to the clips 48 has multi-directional resistance to being dislodged. In one embodiment, a tissue box holder 100 can be attached to the attachment device 10, as seen in FIG. 4. The tissue box holder 100 has connection means in the form of four undercut apertures in its base, onto which the clips 48 of the female connector 40 engage to securely connect the holder 100 to the female connector 40.

The tissue box holder 100 is open-ended, for allowing easy insertion and removal of a tissue box (not shown). The holder 100 has a first aperture opposite the open end to facilitate easy displacement of the tissue box for removal. The holder 100 has a second aperture through its surface opposite the attachment device, for tissues to pass through in use.

Depending on the orientation of the support that the strap is attached to, the holder 100 may be used in different orientations. For example, if attached to a substantially horizontal support, the second aperture would allow tissues to extend substantially upwardly through the aperture. In another example, if attached to a substantially vertical support, tissues would be allowed to extend substantially horizontally through the second aperture.

Within the holder 100, internal ridges retain the tissue box in position during use. The ridges centre the box within the holder 100. In this embodiment, ridges are provided on each internal surface of the holder 100. A further ridge is disposed along an upper face of the holder 100 to one side of the first aperture, angling tissues from the box towards the dentist or patient as needed (depending on the holder orientation).

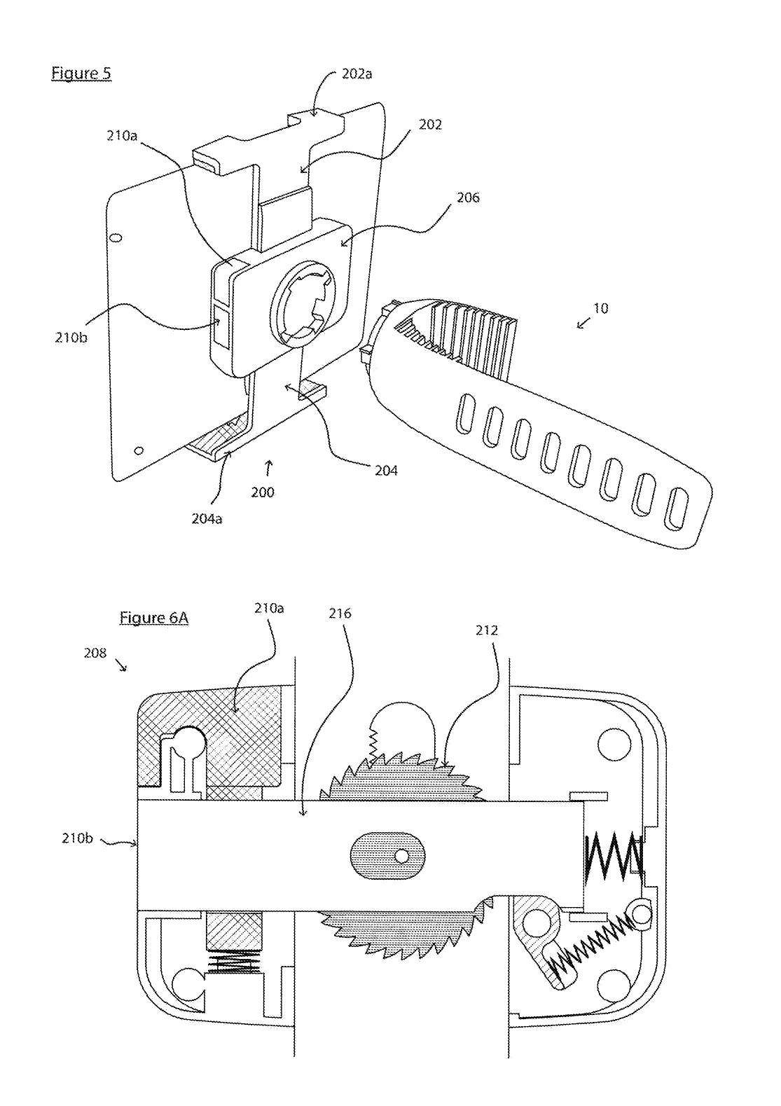

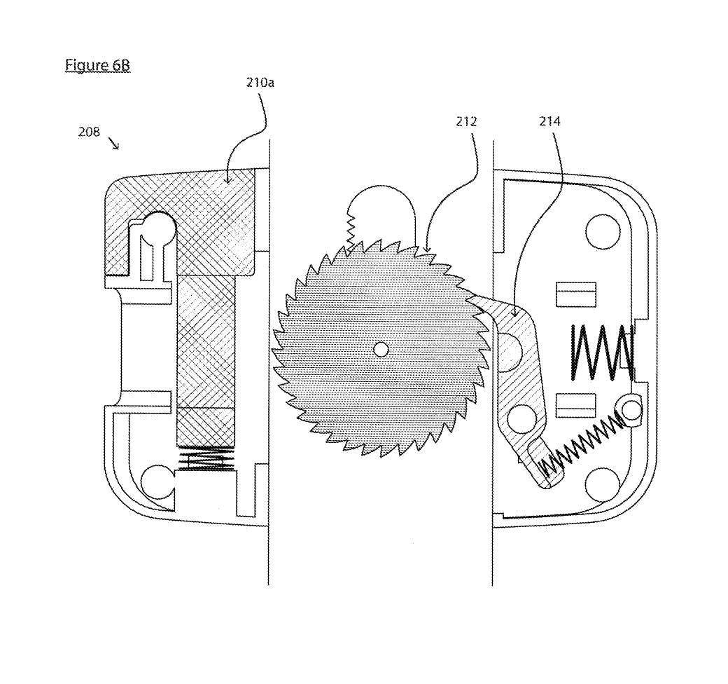

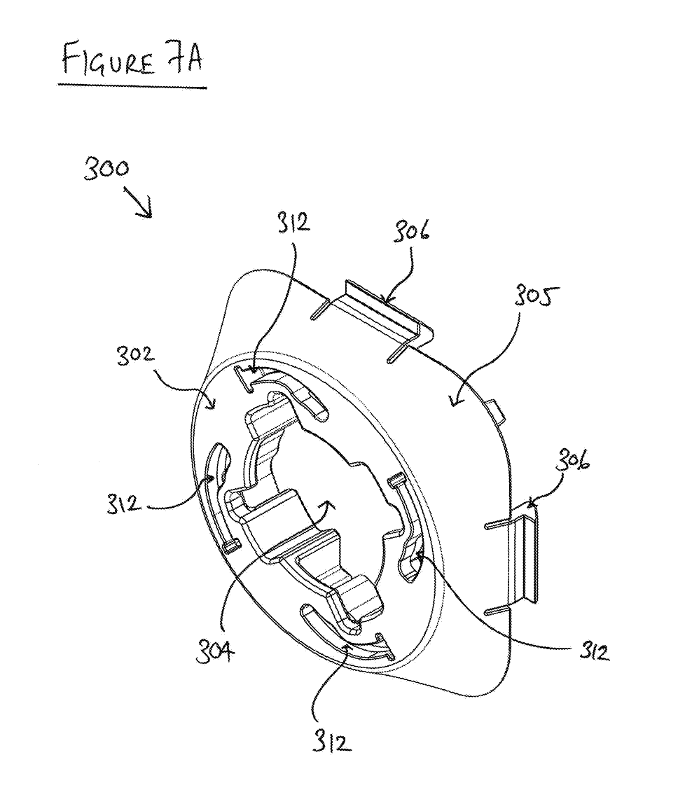

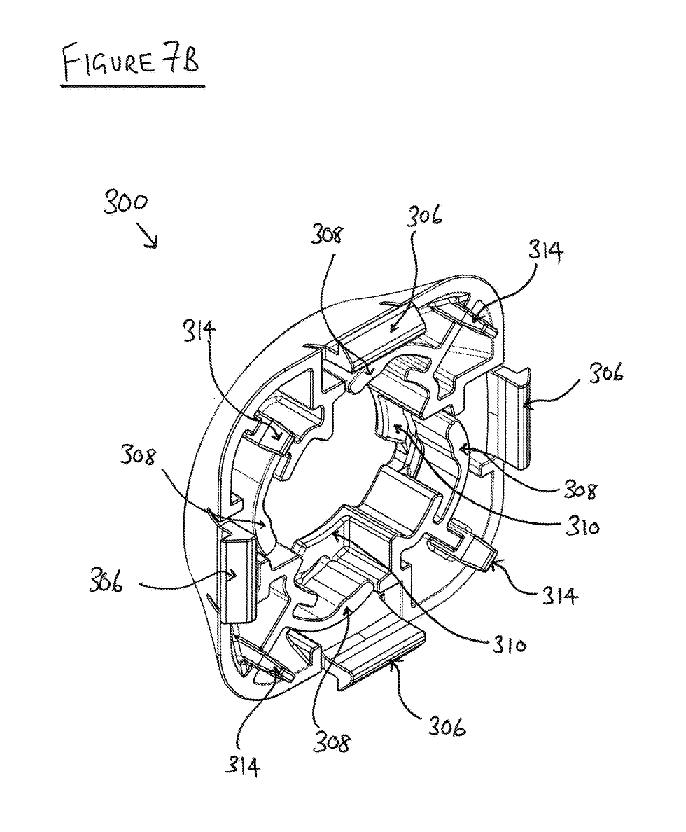

Referring also to FIGS. 5 to 6B, the attachment device 10 is shown in proximity to a clamp device, indicated generally at 200. The clamp device is shown to be clamped around a tablet computer 300 in this embodiment, although other devices may be held within the clamp.

The clamp 200 includes a first arm 202, a second arm 204, and a body 206. Each arm 202, 204 has a distal hook portion 202a, 204a. Each hook portion 202a, 204a includes a resilient rubberised inner portion, to prevent the clamped device from slipping within the clamp 200. The first and second arms 202, 204 are slidably connected to the body 206. In other words, the distance between the hook portions 202a, 204a is variable by adjusting the positions of the arms 202, 204.

An adjustment mechanism 208 is provided for re-positioning the arms 202, 204. The adjustment mechanism is housed within the body 206, as seen in FIGS. 6A and 6B. Locking and unlocking buttons 210a, 210b are provided on the body 206. When the locking button 210a is pressed, the arms 202, 204 are locked in place, preventing them from being spread apart, but allowing them to be brought closer together. When the unlocking button 210b is pressed, the arms 202, 204 are unlocked, allowing them to be spread apart or brought closer together.

The adjustment mechanism 208 includes a ratchet 212 and a spring-loaded pawl 214 which together prevent spreading of the arms 202, 204 when mutually engaged (i.e. in a locked state). The buttons 210a, 210b control the position of the pawl 214 relative to the ratchet 212. The unlocking button 210b is a spring-loaded slider 216, which further connects to the pawl 214. Pressing the unlocking button 210b pushes the slider 216 towards the pawl 214, in turn disengaging the pawl 214 from the ratchet 212, allowing free movement of the arms 202, 204. At the same time, the locking button 210a is sprung to move outwardly when the slider 216 in is moved, locking the slider 216 in place to maintain the adjustment mechanism in an unlocked state. The locking button 210a then protrudes from the body to signal that it is primed. Pressing the locking button 210a releases the slider 216 to spring away from the pawl 214, which in turns reengages the ratchet 212, putting the adjustment mechanism back into a locked state.

In use, the attachment device 10 is placed onto a support with the connector 14 facing outwardly and the engagement portions 16, 18 hanging downwardly. The first engagement portion 16 is brought in proximity to the second engagement portion 18 to give a tight fit to the support, deforming the fins 20, 22 to allow alignment of the apertures 24 with the upstands 26, 28 whilst retaining the device 10 securely. The upstands 26, 28 are forced through two of the apertures 24, over the respective lips 26a, 28a, 28b, and the free end of the strap 11 is then secured via a third of the apertures 24 to the second upstand 28.

The adapter 40 is connected to the connector 14, and locked in place by rotation to secure the snap-fit connection. A secondary device is then connected to the adapter 40 for use, such as the tissue box holder 100, which is secured by engaging the clips 48 of the adapter 40, and then ready for use. Alternatively, the adapter 40 can be connected to the secondary device, e.g. the tissue box holder 100, and subsequently connected to the connector 14.

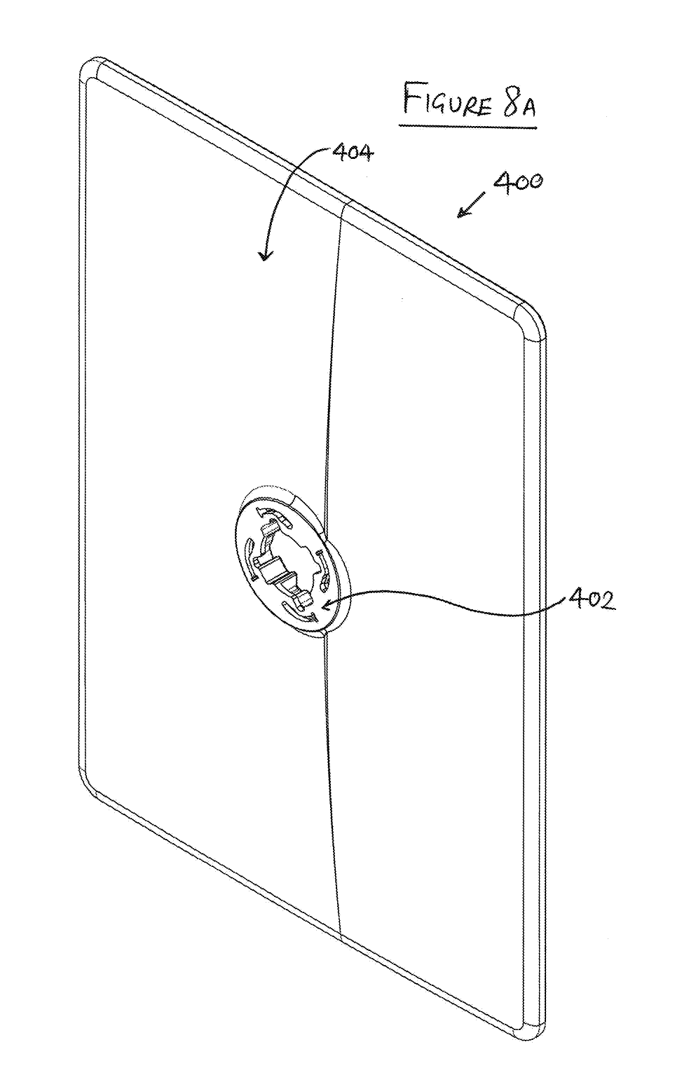

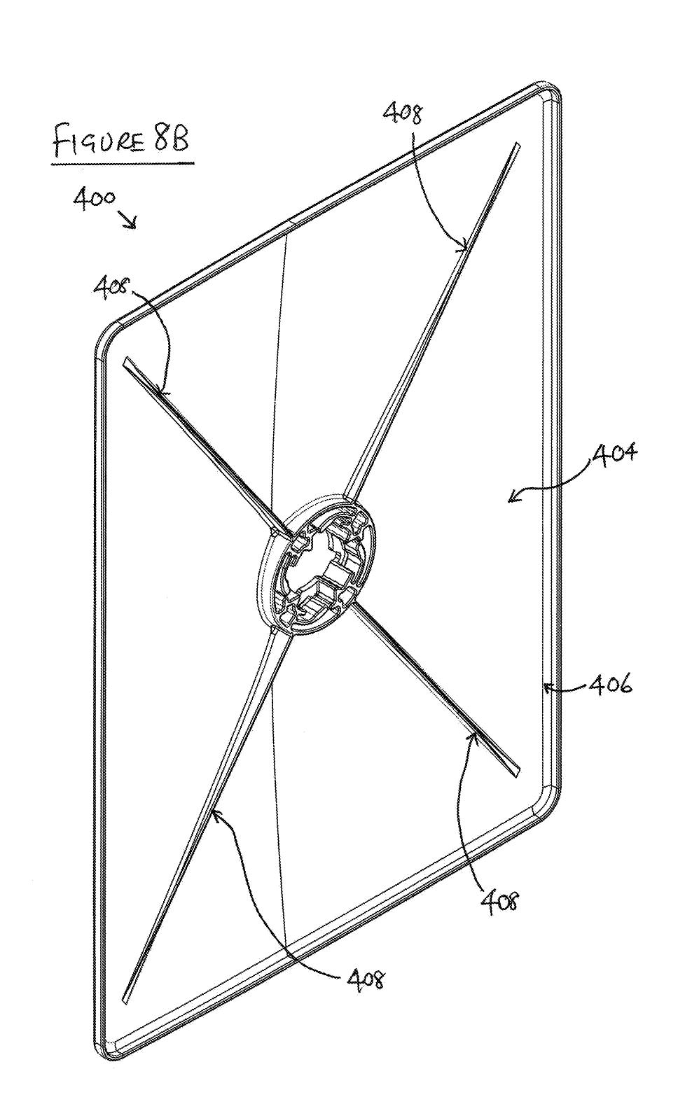

Referring to FIGS. 7A and 7B, an adapter for a tissue box holder is indicated generally at 300. The adapter 300 is designed to receive the male connector 34. The adapter 300 includes a recess with a complementary shape to the male connector 34. The adapter 300 may in alternative embodiments be integrally moulded into the tissue box holder 100. The features of the adapter 300 are similar to the features of the female connector 40 described above, and the following description mainly focuses on the different features.

The adapter 300 has a body 302 with an aperture 304 for receiving the connector 34. The body 302 includes a skirt 305 around the periphery of the aperture 304. Four resilient clips 306 are provided around the edge of the skirt 305, for connection to or through corresponding slots in the tissue box holder 100. The clips 306 are conventional resilient clips and pass through the slots, whilst flexing inwardly during connection to the holder 100. When the adapter is in position against the holder 100, the clips 306 spring back and hold it in place.

Flexible tangs 308 are provided in the body 302 for securing the male connector 34 to the body 302. The tangs 308 are provided behind the clips 306. The tangs 308 are spaced from the skirt 305. The tangs 308 operate in the same way as the flexible arms described for FIG. 3B, providing a snap-fit connection.

The male connector 34 is engaged with the adapter 300 by relative rotation of one against the other. The radial protrusions 36 of the connector 34 bear against the flexible tangs, displacing them substantially radially outwards into the space behind the skirt 305, when sufficient rotational force is applied to flex the tangs 308.

When the nubs 38 of the connector 34 have been rotated past the flexible tangs 308, the tangs 308 return to their native positions, and bear against the nubs 38 to latch the connector 34 in place against the body 302 of the adapter 300. Reverse rotation of the connector 34 (from a latched position) using sufficient force displaces the tangs 308 outwardly to release the connector 34. Ledges 310 are provided adjacent to the tangs 308 for preventing axial disconnection of the adapter 300 and connector 34 when latched together.

Slots 312 are provided on the front of the adapter 300. The flexible tangs 308 can be seen in operation through these slots, when latching the connector 34 to the adapter 300.

The adapter 300 remains connected to the tissue box holder 100 when disconnecting the connector 34. Due to the rotational force involved, the clips 306 are placed under stress orthogonal to their normal direction of flex. Locator pins 314 are provided in corners of the adapter 300 to bear some of the rotational load, mitigating this stress.

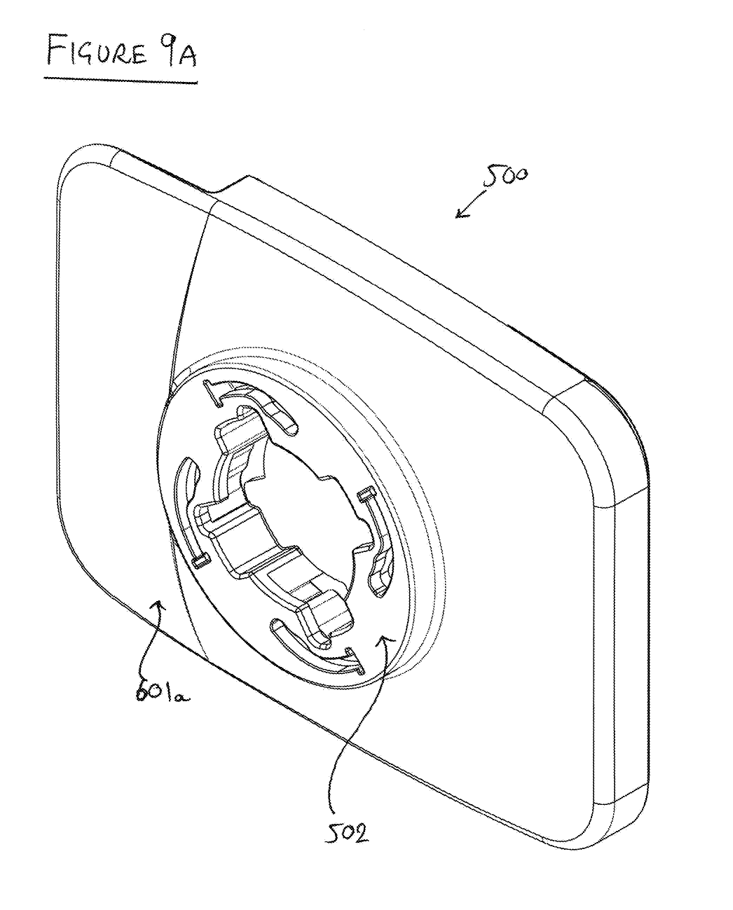

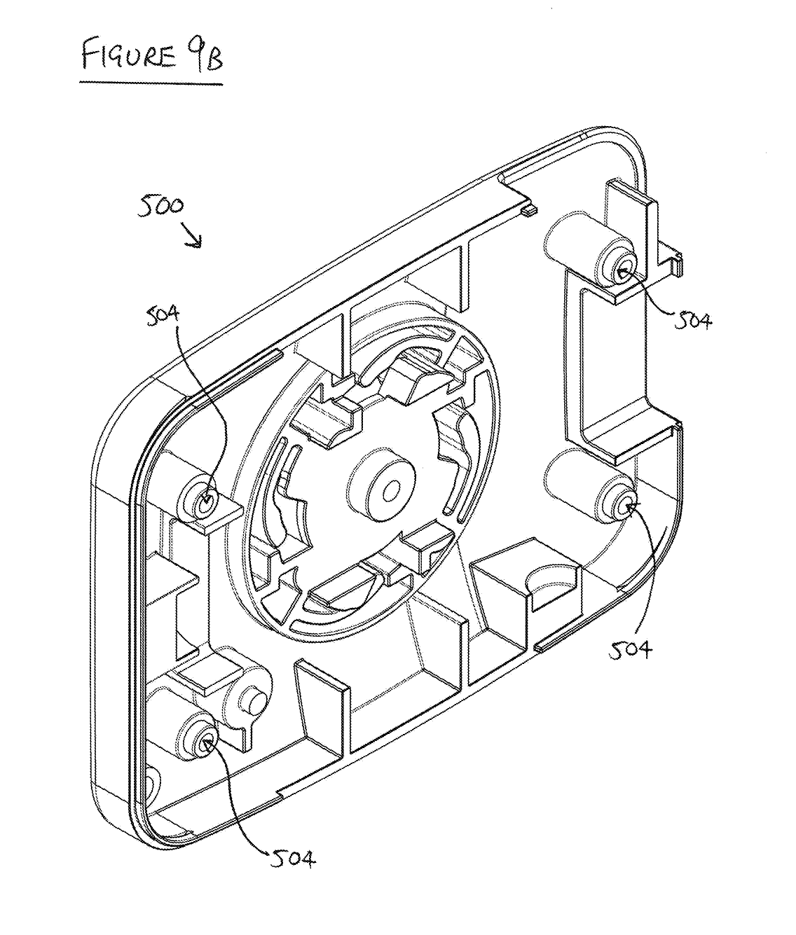

Referring to FIGS. 8A and 8B, an adapter for a mirror is indicated generally at 400. The adapter 400 is designed to receive the male connector 34. The adapter 400 includes a recess with a complementary shape to the male connector 34. The mirror is not shown, but can be bonded to the adapter 400. The adapter 400 may be integrally formed with the mirror in some embodiments. The features of the adapter 400 are similar to the features of the female connector 40 and tissue box adapter 300 described above, and the following description mainly focuses on the different features.

Unlike the tissue box adapter 300, the mirror adapter 400 does not include a skirt. Instead, the adapter 400 has a body 402 with a frame 404 extending around the periphery of the body 402. The frame 404 is constructed to receive a mirror (not shown). A lip 406 is provided around the edges of the frame 404 to bear against edges of a mirror. The frame 404 also includes oblique supports 408 to support the rear face of a mirror, when installed in the frame 404. The frame 404 has rounded corners and edges.

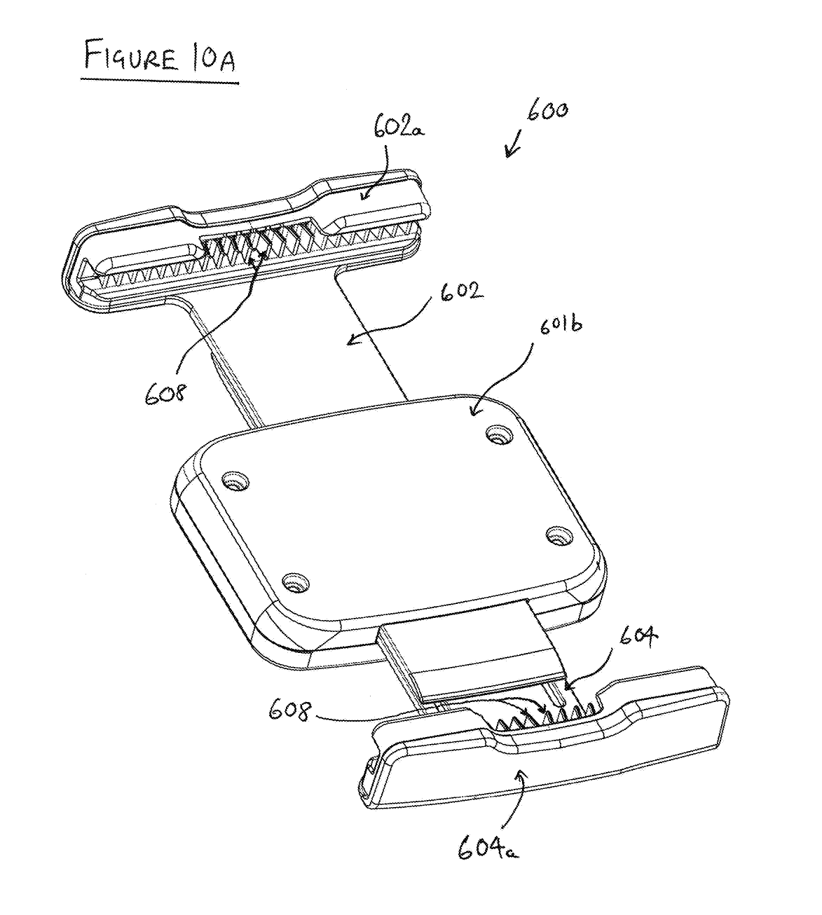

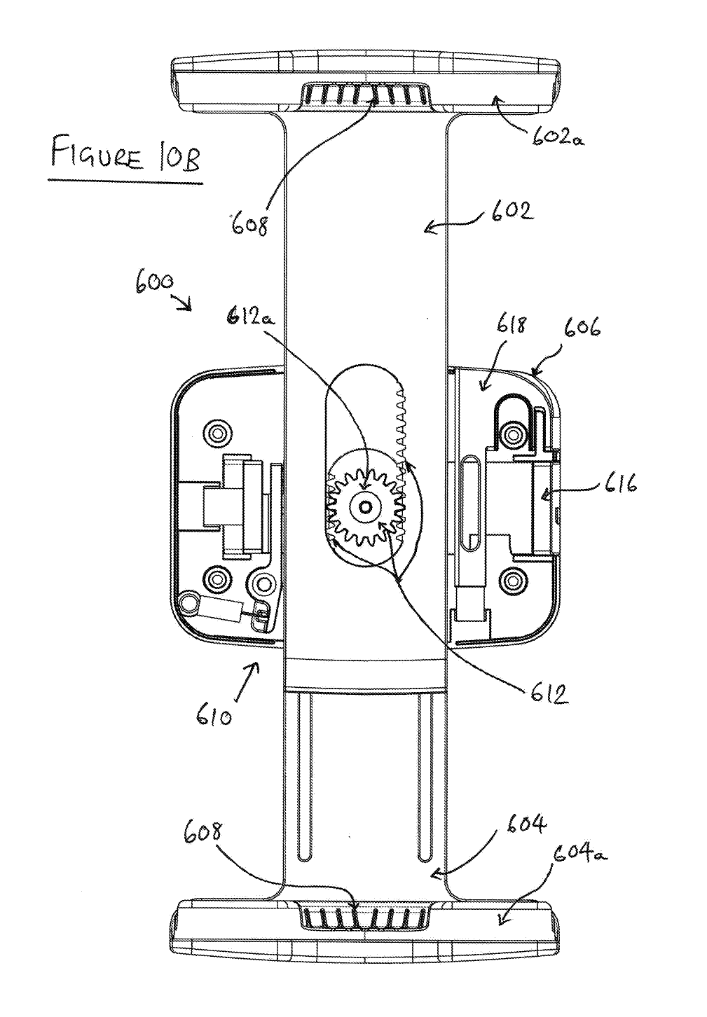

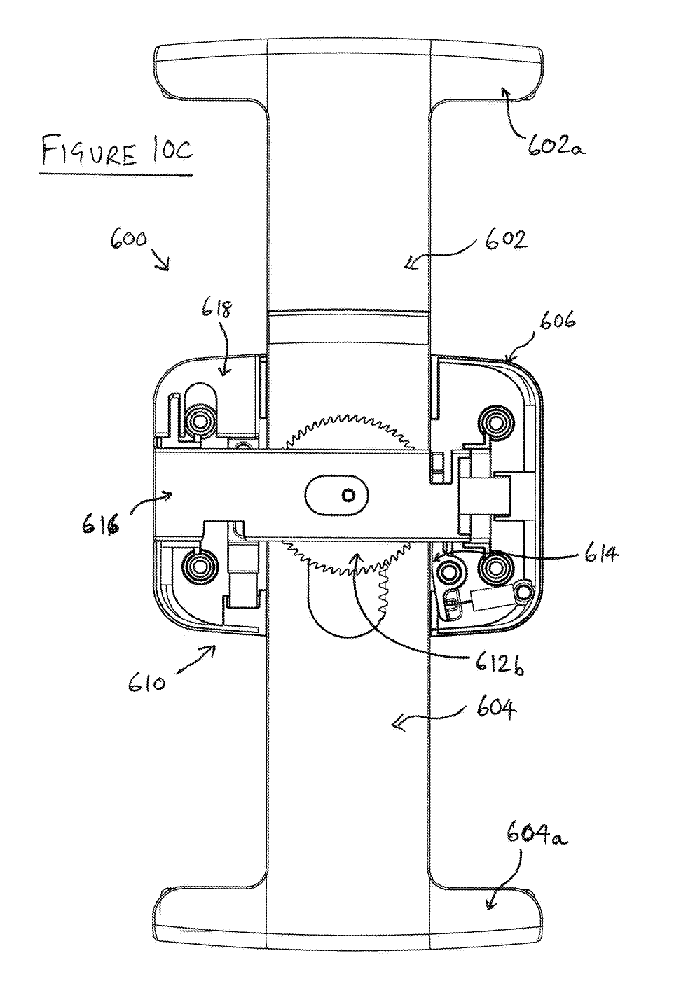

Referring to FIGS. 9A to 10C, an adapter for a clamp is indicated generally at 500 and an embodiment of a clamp is indicated generally at 600. The adapter 500 is designed to receive the male connector 34. The adapter 500 includes a recess with a complementary shape to the male connector 34. The clamp 600 is designed to hold a tablet or similar device. The features of the adapter 500 are similar to the features of the female connector 40 and tissue box adapter 300 described above, and the following description mainly focuses on the different features.

The adapter 500 in this embodiment forms a back panel 601a of the clamp 600. A body 502 of the adapter includes means 504 for receiving screws, for example, inserted through a front panel 601b of the clamp 600. The body 502 is also shaped to accommodate a lockable clamp adjustment mechanism within the clamp 600.

The clamp 600 is shown in FIGS. 10A to 10C. The features of the clamp 600 are similar to the features of the clamp 200 described above, and the following description mainly focuses on the different features.

The clamp 600 includes first and second arms 602, 604, slidably connected on either side of a central body 606. Distal grips 602a, 604a are provided at the outermost end of each arm 602, 604. The distal grips 602a, 604a are wider than the arms 602, 604, being approximately as wide as the body 606 in this embodiment. The grips 602a, 604a can be repositioned relative to the body 606 by sliding the arms 602, 604. This is achieved via an adjustment mechanism 610.

In this embodiment, each distal grip 602a, 604a includes a series of fins 608 for gripping an object in the clamp 600. The fins 608 in each series face towards the body 606. A portion of the fins 608 in each series are angled or slant towards one side of the body 606. The remaining fins 608 in each series are angled or slant towards the other side of the body 606. In this embodiment, half of the fins in each series slant left along parallel lines, and the other half of the fins in each series slant right along parallel lines.

The fins 608 are made of a resilient, rubberised material, for example, a thermoplastic elastomer. This provides a high grip surface, i.e. having a high coefficient of friction. When a tablet computer is placed in the clamp 600, the fins 608 are compressed together, bearing against neighbouring fins 608 and the tablet computer. The fins 608 also deform around the edge of the tablet computer under compression, increasing the contact area.

The fins 608 of one arm 602 face towards the fins 608 of the other arm 604. Each fin 608 is secured to a surface of the relevant distal grip 602a, 604a which is substantially orthogonal to the plane of motion of the arms 602, 604. The fins 608 have a large collective surface area, and so do not slide past or over one another easily. This improves the grip on the tablet computer, preventing it from sliding or being knocked out of the clamp 600 in a direction perpendicular to the sliding direction of the arms.

The adjustment mechanism 610 is housed in the body 606. The features of the adjustment mechanism are largely similar to those of the mechanism 208 in FIGS. 6A and 6B. A dual rack and pinion arrangement 612 is used to move the arms 602, 604 simultaneously, ensuring the arms are spaced evenly from the body 606. A gear 612a in the rack and pinion arrangement is fixed to a second gear 612b, which is disposed behind the other gear 612a.

A sprung pawl 614 is provided to engage the second gear 612b and lock the rack and pinion arrangement, preventing movement of the arms 602, 604. A similar arrangement is shown in FIG. 6B. Pressing an unlocking button 616 displaces the pawl 614 from the second gear 612b, allowing adjustment of the arms 602, 604. Here, the unlocking button is a spring-loaded slider. Pressing a locking button 618 causes the pawl 614 to spring into engagement with the second gear 612b. When engaged, the second gear 612b is and pawl 614 allow ratcheting in a direction which closes the arms 602, 604, i.e. brings the arms closer to the body 606. When disengaged, the arms are moveable towards or away from the body 606, although their positions are still interdependent.

Accessories and adapters as described for any of FIGS. 7A to 10C can be used with and supported by the attachment device 10. In some embodiments, where the adapter 300, 400, 500 is part of the relevant accessory or secondary device, the adapter 300, 400, 500 can be connected to the connector 34 by aligning the complementary sections of the relevant adapter and connector 34, bringing those sections into engagement, and rotating one relative to the other to latch that adapter in place.

It will be appreciated that any of the adapters for the mirror, tissue box holder, and/or clamp may be bonded to or integrally moulded with the relevant accessory.

Alternatively, any of the adapters may be provided separately from the relevant accessory, being releasably fastenable to that accessory.

In alternative embodiments, it is envisaged that other types of rubber, including variations on silicone rubber, may be used to form the strap. In some embodiments, the strap is overmoulded to the connector. This prevents disconnection of the connector from the strap. It will be appreciated that the second aperture of the tissue box holder may alternatively be provided on another surface of the holder, adjacent to the attachment device, for example. Tissues may as such issue from and be taken from any surface of the holder in different embodiments.

The embodiments described above are provided by way of example only, and various changes or modifications will be apparent to persons skilled in the art without departing from the scope of the present invention as defined by the appended claims.

1-38. (canceled)

39. A combination for attaching accessories to a support and supporting a display, comprising:
an attachment device for attaching accessories to the support, comprising
a connector for connecting to the clamp, and
a strap for attachment around the support in use, the strap having a support region mounting the connector, and first and second flexible engagement portions,
the first engagement portion including a plurality of spaced deformable fins extending from one side thereof and a plurality of through apertures spaced along the length of the first engagement portion, and
the second engagement portion including a plurality of spaced deformable fins extending from one side thereof, and at least one upstand extending from the other side thereof adapted to enter and engage with at least one of the through apertures of the first engagement portion; and
a clamp for supporting the display comprising
an adapter for connection to the attachment device,
first and second opposing arms connected to a body, a grip area being provided at the end of each arm, the adapter being provided on the body, and
an arm adjustment mechanism slidably connecting the arms to the body, the mechanism being operable to slide and lock the arms in one or more positions relative to the body.

40. The combination of claim 39, wherein the strap is integrally formed from rubber.

41. The combination of claim 39, wherein the first and second engagement portions extend away from the support region, to the same side of the support region, and spaced apart.

42. The combination of claim 39, wherein the fins extend laterally across the first and second engagement portions.

43. The combination of claim 39, wherein the fins on the first engagement portion face the fins on the second engagement portion.

44. The combination of claim 39, wherein the fins substantially decrease in depth with distance from the support region.

45. The combination of claim 39, wherein first and second spaced upstands are provided on the other side of the second engagement portion to the fins.

46. The combination of claim 45, wherein the spacing of the first and second upstands corresponds to the spacing of the plurality of through apertures in the first engagement portion.

47. The combination of claim 45, wherein the first upstand closest to the support portion is a first height and has a lip provided at its distal end, and the second upstand has a second height, taller than the first height, and has a first lip located part way along its length and a second lip at its distal end.

48. The combination of claim 47, wherein the first engagement portion can be attached to the second engagement portion to form a closed loop for gripping an elongate member by engaging adjacent apertures on the first and second upstands, and then folding the first engagement portion back on itself and engaging a further aperture on the second upstand.

49. The combination of claim 39, wherein the connector has connection means extending to one side for engaging a corresponding connector, the connection means being a male or female bayonet connector for connecting to a corresponding female or male bayonet connector.

50. The combination of claim 49, wherein which a snap fit connection is provided between the adapter and connector.

51. The combination of claim 39, wherein the adapter is one of bonded to, integrally formed with, or releasably fastenable to the clamp.

52. The combination of claim 39, wherein the clamp includes adjustable first and second opposing jaws slidably connected to the body.

53. The combination of claim 52, wherein the body includes a ratchet mechanism switchable between a locked configuration, where the first and second jaws cannot be spread apart, and an unlocked configuration, where the first and second jaws can be moved freely.

54. The combination of claim 53, wherein the ratchet mechanism includes a ratchet and a spring-loaded pawl arranged for engagement with the ratchet, where the pawl engages the ratchet in the locked configuration.

55. The combination of claim 39, wherein one or both grip areas include a plurality of spaced deformable fins.

56. The combination of claim 39, wherein the adapter includes a bayonet connector having a receiving area for receiving a corresponding bayonet connector of the attachment device, one of the bayonet connectors having one or more radial protrusions disposed to engage one or more corresponding latches in the other connector during relative rotation of the engaged connectors, preventing axial separation of the connectors.

57. A combination for attaching accessories to a support, comprising:
an attachment device for attaching accessories to the support comprising,
a connector, and
a strap configured to attach to a support, the strap having the strap having a support region mounting the connector, a first engagement portion and a second engagement portion,
the first engagement portion including a plurality of spaced deformable fins extending from one side thereof and a plurality of through apertures spaced along the length of the first engagement portion,
the second engagement portion including a plurality of spaced deformable fins extending from one side thereof, and at least one upstand extending from the other side thereof adapted to enter and engage with at least one of the through apertures of the first engagement portion; and
an accessory comprising an adapter configured to connect with the connector of the attachment device.

58. An attachment device for attaching accessories to a support, the attachment device comprising:
a connector configured to attach to an accessory, and
a strap configured to attach to the support in use, the strap having a support region mounting the connector, and a first engagement portion and a second engagement portion,
the connector extending outwardly from the support region, away from the flexible engagement portions,
the first engagement portion including a plurality of spaced deformable fins extending from one side thereof and a plurality of through apertures spaced along the length of the first engagement portion,
the second engagement portion including a plurality of spaced deformable fins extending from one side thereof, and at least one upstand extending from the other side thereof adapted to enter and engage with at least one of the through apertures of the first engagement portion,
in use, when the strap is attached to the support, the connector facing outwards and being free to connect to the accessory.
